(19) United States
(12) Patent Application Publication
(10) Pub. No.: US 2012/0113655 A1
(43) Pub. Date: May 10, 2012

(54) Street Lamp

(75) Inventors: Huan-Chang Huang, Taoyuan County (TW); Chun-Kai Chang, Taoyuan County (TW)

(73) Assignee: Huan-Chang Huang, Taoyuan County (TW)

(21) Appl. No.: 13/035,185

(22) Filed: Feb. 25, 2011

(30) Foreign Application Priority Data
Nov. 4, 2010 (TW) 099221375

(51) Int. Cl. F21V 29/00

(52) U.S. Cl. 362/373

(57) ABSTRACT

A street lamp includes a shell, a mount, a radiation unit and an illumination unit. The shell includes an opening defined therein. The mount is located in and connected to the shell. The radiation unit is connected to the mount. The illumination unit is connected to the radiation unit. The illumination unit can emit light that can travel through the opening.

### BACKGROUND OF INVENTION

1. Field of Invention

The present invention relates to a streetlamp and, more particularly, to a street lamp that is made inexpensively, consumes a little energy, radiates heat excellently, and can be maintained easily.

2. Related Prior Art

A conventional street lamp includes a shell, a socket located in the shell, a light bulb partially inserted in and electrically connected to the socket, and a lens connected to the shell for protectively covering the socket and the light bulb. In use, the shell is connected to a post. The socket is electrically connected to the mains or grid. Thus, the mains or grid can energize the light bulb to emit light that travels through the lens for illumination.

The conventional street lamp provides illumination. However, the use of the conventional street lamp is not without any problems. Firstly, it consumes a lot of energy for including the light bulb. Secondly, it does not last long because the light bulb could easily overheat without including any effective radiation device. Thirdly, it is expensive for including the lens and the light bulb. Fourthly, it cannot be maintained before the lens is removed from the shell with risks that the lens could be broken during the manipulation.

The present invention is therefore intended to obviate or at least alleviate the problems encountered in prior art.

### SUMMARY OF INVENTION

It is the primary objective of the present invention to provide a street lamp that is made inexpensively, consumes a little energy, radiates heat excellent, and can be maintained easily.

To achieve the foregoing objective, the street lamp includes a shell, a mount, a radiation unit and an illumination unit. The shell includes an opening defined therein. The mount is located in and connected to the shell. The radiation unit is connected to the mount. The illumination unit is connected to the radiation unit. The illumination unit can emit light that can travel through the opening.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a perspective view of a street lamp according to the first embodiment of the present invention;

FIG. 2 is an exploded view of the street lamp shown in FIG. 1;

FIG. 3 is a cross-sectional view of the street lamp shown in FIG. 1; and

FIG. 4 is a bottom view of a street lamp according to the second embodiment of the present invention.

### DETAILED DESCRIPTION OF EMBODIMENTS

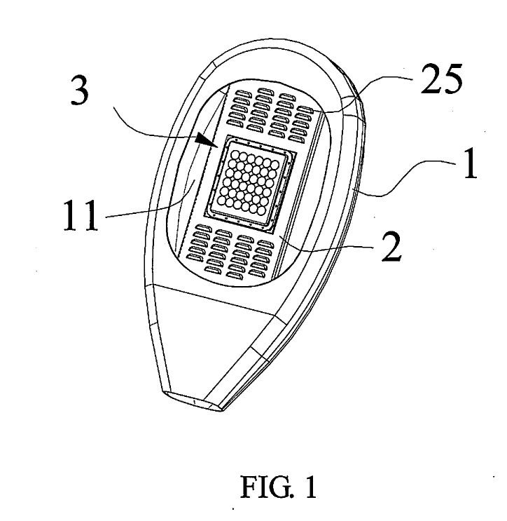

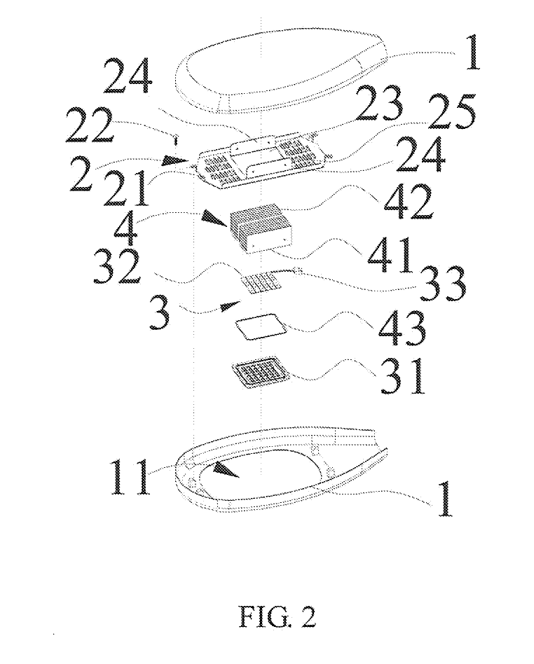

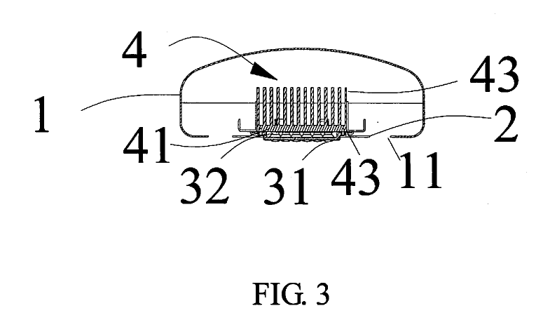

Referring to FIGS. 1 to 3, there is shown a street lamp according to a first embodiment of the present invention. The street lamp includes a shell 1, a mount 2, an illumination unit 3 and a radiation unit 4. The shell 1 includes a cap and a frame connected to the cap. The frame includes an opening 11 defined therein.

The mount 2 is substantially a metal plate. The mount 2 includes several lugs 21 formed thereon, a window 23 defined therein, two leaves 24 formed thereon, and a plurality of drains 25 defined therein. Each of the lugs 21 preferably includes a slot defined therein. The window 23 is located between the leaves 24 that extend parallel to each other.

The illumination unit 3 includes an LED array 32, a plug 33 electrically connected to the led array 32, and a lens 31 for protectively covering the LED array 32. Preferably, the LED array 32 is electrically connected to the plug 33 through a wire. The plug 33 is preferably a quick coupling. The lens 31 preferably includes a groove defined therein.

The radiation unit 4 is made of metal. The radiation unit 4 includes a heat sink and a gasket 43. The heat sink includes a base 41 and a plurality of fins 42 extending from the base 41. The gasket 43 is used for sealing.

In assembly, the frame of the shell 1 is connected to the cap of the shell 1 by screws. The LED array 32 is located within the gasket 43 before they are located between the base 41 and the lens 31. The gasket 43 is partially located in the groove defined in the lens 31. The lens 31 is connected to the base 41 by screws. The base 41 is connected to the leaves 24 by screws. The mount 2 is connected to the cap of the shell 1 by driving the screws 22 in the cap of the shell 1 through the slots defined in the lugs 21.

In use, the shell 1 is connected to a post, and the plug 33 is inserted in a socket of the mains or grid. Thus, the mains or grid can energize the LED array 32 to emit light that can travel through the window 23 and the opening 11. The light emitted from the LED array 32 is evenly scattered by the lens 31. The gasket 43 is sandwiched between the base 41 and the lens 31 so that the LED array 32 is protected from water or any other contaminants. The opening 11 and the drains 25 allow water to drain from the shell 1 so that not a considerable amount of water would become steam that would eventually damage the LED array 32 in the shell 1. The base 41 effectively receives heat from the LED array 32, and the fins 42 effectively radiate the heat from the base 41. The opening 11 allows the heat to leave the shell 1 while allowing cool air to enter the shell 1 for cooling.

In maintenance, the mount 2 can easily be removed from the shell 1 by removing the screws 22. The radiation unit 4 can easily be removed from the mount 2 by removing the screws. The lens 31 can easily be removed from the base 41 by removing the screws. Thus, all of the elements can easily be reached and maintained.

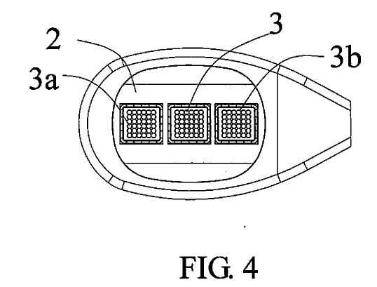

Referring to FIG. 4, there is shown a street lamp according to a second embodiment of the present invention. The second embodiment is like the first embodiment except including two more illumination units 3a and 3b identical to the illumination unit 3. The illumination units 3, 3a and 3b may share a common radiation unit or include their own radiation units.

The street lamp of the present invention exhibits several advantages over the prior art. At first, it consumes a little energy for including the LED array 32. Secondly, it radiates heat excellently for including the radiation unit 4 and the opening 11. Thirdly, it is inexpensive without including any expensive light bulb and any expensive large lens. Fourthly, it can be maintained easily and inexpensively.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A street lamp comprising: a shell 1 including an opening 11 defined therein, a mount 2 located in and connected to the shell 1, a radiation unit 4 connected to the mount 2, and an illumination unit 3 connected to the radiation unit 4, wherein the illumination unit 3 can emit light that can travel through the opening 11.

2. The street lamp according to claim 1, wherein the mount 2 includes a plurality of drains 25 defined therein.

3. The street lamp according to claim 1, wherein the mount 2 include lugs 21 formed thereon and screws 22 driven into the shell 1 through the lugs 21.

4. The street lamp according to claim 1, wherein the mount 2 includes a window 23 defined therein corresponding to the opening 11.

5. The street lamp according to claim 1, wherein the illumination unit 3 includes a lens 31 attached to the radiation unit 4, an LED array 32 located between the lens 31 and the radiation unit 4, and a plug 33 electrically connected to the LED array 32.

6. The street lamp according to claim 5, wherein the plug 33 is a quick coupling.

7. The street lamp according to claim 1, wherein the radiation unit 4 includes a base 41 in contact with the illumination unit 3, a plurality of fins 42 extending from the base 41, and a gasket 43 located between the base 41 and the illumination unit 3.
